(19) United States
(12) Patent Application Publication
(10) Pub. No.: US 2014/0024344 A1
(43) Pub. Date: Jan. 23, 2014

(54) MOBILE COMMUNICATION METHOD, RADIO BASE STATION, MOBILE MANAGEMENT NODE, AND MOBILE STATION

(71) Applicants: Mikio Iwamura, Chiyoda-ku (JP); Wuri Andarmawanti Hapsari, Chiyoda-ku (JP)

(72) Inventors: Mikio Iwamura, Chiyoda-ku (JP); Wuri Andarmawanti Hapsari, Chiyoda-ku (JP)

(73) Assignee: NTT DOCOMO, INC., Tokyo (JP)

(21) Appl. No.: 14/009,370

(22) PCT Filed: Mar. 30, 2012
(86) PCT No.: PCT/JP2012/058606

§ 371 Date: Oct. 2, 2013

(30) Foreign Application Priority Data
Apr. 5, 2011 (JP) 2011-083696

(51) Int. Cl. H04W 12/04

(52) U.S. Cl. CPC H04W 12/04
USPC 455/411

(57) ABSTRACT

A mobile communication method according to the present invention includes: a step of updating, by a radio base station eNB or a mobile management node MME, a key Kₓ to be used for transmission/reception of a data signal through an Ud interface or a predetermined parameter X for calculating the key Kₓ when the radio base station eNB or the mobile management node MME has received an “SN wrap indication” or a key update request signal from a mobile station UE#1 or a mobile station UE#2; a step of notifying, by the radio base station eNB or the mobile management node MME, the mobile station UE#1 and the mobile station UE#2 of the updated key Kₓ or the updated predetermined parameter X; and a step of continuing, by the mobile station UE#1 and the mobile station UE#2, transmission/reception of the data signal.

### TECHNICAL FIELD

The present invention relates to a mobile communication method, a radio base station, a mobile management node, and a mobile station.

### BACKGROUND ART

In cellular mobile communication systems such as a wideband-code division multiple access (W-CDMA) system and a long term evolution (LTE) system, it is configured such that communication among a plurality of mobile stations UE is performed through a radio access network device, a core network device, and the like.

### CITATION LIST

### Non-Patent Literature

Non-Patent Literature 1: 3GPP TS36.300

### SUMMARY OF INVENTION

### Technical Problem

However, in a previous cellular mobile communication system, even in a case where a plurality of mobile stations UE is located in the same cell (or in a cell under control of a radio access network device), it is configured such that both of a data signal and a control signal are transmitted/received through the radio access network device, and thus there is a problem of an increase in processing load of the radio access network device.

To solve the problem, transmission/reception of the data signal through an interface between mobile stations (hereinafter, a Ud interface) without through Uu interfaces set between the mobile stations and a radio base station can be assumed.

Further, in such a case, to secure security (detection of concealment or falsification) of the data signal transmitted/received through the Ud interface, use of a key for transmission between the mobile stations (hereinafter, a key Kₓ) different from a key used for securing security (detection of concealment or falsification) of the data signal transmitted/received through the Uu interface is assumed.

Here, generally, using the same key for a long time as a key used for communication leads to vulnerability of security, and thus it is important to frequently update the key to some extent. For example, it is desired to update the key before a sequence number (SN) of data comes up again in a round.

However, there is a problem that an existing mobile communication system cannot update the key Kₓ at an appropriate timing.

Therefore, the present invention has been made in view of the foregoing, and an objective of the present invention is to provide a mobile communication method, a radio base station, a mobile management node, and a mobile station capable of updating a key Kₓ at an appropriate timing.

A first feature of the present invention is a mobile communication method of performing transmission/reception of a data signal between a first mobile station and a second mobile station through an interface between mobile stations set between the first mobile station and the second mobile station without through a radio base station interface set between the first mobile station and the second mobile station, and the radio base station, the method including the steps of: transmitting, to the radio base station from the first mobile station or the second mobile station, an instruction signal indicating a timing of one cycle of a sequence number of the data signal transmitted/received through the interface between mobile stations is approaching, or a key update request signal requesting update of a key; updating, by the radio base station or a mobile management node, a key for communication between mobile stations to be used for transmission/reception of the data signal through the interface between mobile stations, or a predetermined parameter for calculating the key for communication between mobile stations when the radio base station or the mobile management node has received the instruction signal or the key update request signal; notifying, by the radio base station or the mobile management node, the first mobile station and the second mobile station of the updated key for communication between mobile stations or the updated predetermined parameter; and updating, by the first mobile station and the second mobile station, the key for communication between mobile stations to be used for transmission/reception of the data signal through the interface between mobile stations to a key for communication between mobile stations calculated based on the notified key for communication between mobile stations or the notified predetermined parameter.

A second feature of the present invention is a radio base station to be used in a mobile communication system configured to perform transmission/reception of a data signal between a first mobile station and a second mobile station through an interface between mobile stations set between the first mobile station and the second mobile station without through a radio base station interface set between the first mobile station and the second mobile station, and the radio base station, the radio base station including: a reception unit configured to receive, from the first mobile station or the second mobile station, an instruction signal indicating a timing of one cycle of a sequence number of the data signal transmitted/received through the interface between mobile stations is approaching, or a key update request signal requesting update of a key; an update unit configured to update a key for communication between mobile stations to be used for transmission/reception of the data signal through the interface between mobile stations, or a predetermined parameter for calculating the key for communication between mobile stations when having received the instruction signal or the key update request signal; and a transmission unit configured to notify the first mobile station and the second mobile station of the updated key for communication between mobile stations or the updated predetermined parameter.

A third feature of the present invention is a mobile management node to be used in a mobile communication system configured to perform transmission/reception of a data signal between a first mobile station and a second mobile station through an interface between mobile stations set between the first mobile station and the second mobile station without through a radio base station interface set between the first mobile station and the second mobile station, and a radio base station, the mobile management node including: a reception unit configured to receive, from the first mobile station or the second mobile station, an instruction signal indicating a timing of one cycle of a sequence number of the data signal transmitted/received through the interface between mobile stations is approaching, or a key update request signal requesting update of a key; an update unit configured to update a key for communication between mobile stations to be used for transmission/reception of the data signal through the interface between mobile stations, or a predetermined parameter for calculating the key for communication between mobile stations when having received the instruction signal or the key update request signal; and a transmission unit configured to notify the first mobile station and the second mobile station of the updated key for communication between mobile stations, or the updated predetermined parameter.

A fourth feature of the present invention is a mobile station functioning as a first mobile station in a mobile communication system configured to perform transmission/reception of a data signal between the first mobile station and a second mobile station through an interface between mobile stations set between the first mobile station and the second mobile station without through a radio base station interface set between the first mobile station and the second mobile station, and a radio base station, the mobile station including: a transmission unit configured to transmit, to the radio base station, an instruction signal indicating a timing of one cycle of a sequence number of the data signal transmitted/received through the interface between mobile stations is approaching, or a key update request signal requesting update of a key; a reception unit configured to receive, from the radio base station or a mobile management node having received the instruction signal or the key update request signal, a key for communication between mobile stations to be used for transmission/reception of the data signal through the interface between mobile stations, or a predetermined parameter for calculating the key for communication between mobile stations; and an update unit configured to update the key for communication between mobile stations to be used for transmission/reception of the data signal through the interface between mobile stations to a key for communication between mobile stations calculated based on the received key for communication between mobile stations or the received predetermined parameter.

### Advantageous Effects of Invention

As described above, according to the present invention, a mobile communication method, a radio base station, a mobile management node, and a mobile station capable of updating a key Kₓ at an appropriate timing can be provided.

### BRIEF DESCRIPTION OF DRAWINGS

FIG. 1 is an overall configuration diagram of a mobile communication system according to a first embodiment of the present invention.

FIG. 2 is a function block diagram of a mobile station according to the first embodiment of the present invention.

FIG. 3 is a diagram for describing an operation of the mobile station according to the first embodiment of the present invention.

FIG. 4 is a function block diagram of a radio base station or a mobile management node according to the first embodiment of the present invention.

FIG. 5 is a sequence diagram indicating an operation of the mobile communication system according to the first embodiment of the present invention.

### DESCRIPTION OF EMBODIMENTS

### (A Mobile Communication System According to a First Embodiment of the Present Invention)

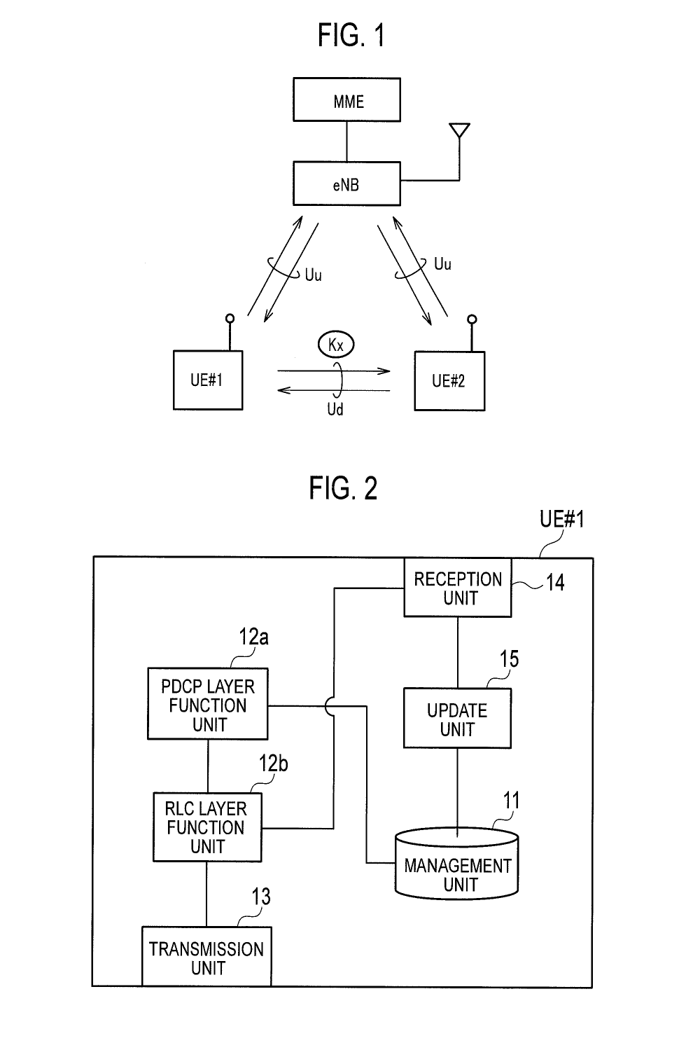

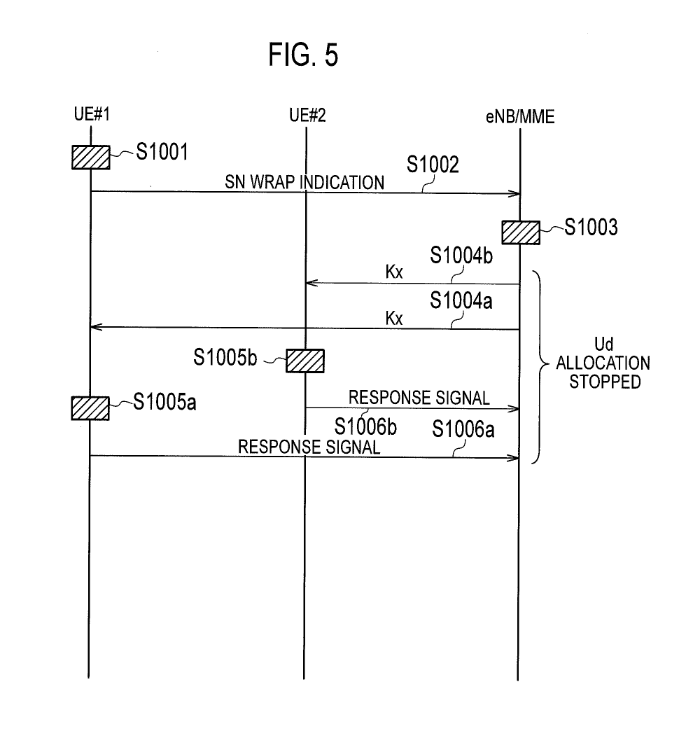

A mobile communication system according to a first embodiment of the present invention will be described with reference to FIGS. 1 and 5.

A mobile communication system according to the present embodiment is an LTE mobile communication system, and is, as illustrated in FIG. 1, provided with a mobile management node MME (mobility management entity) and a radio base station eNB connected under control of the mobile management node MME. Note that the present invention is applicable to a cellular mobile communication system other than the LTE system.

Here, it is configured such that a data signal is transmitted/received between the radio base station eNB and mobile stations UE#1/UE#2 through Uu interfaces, and it is configured such that a data signal is transmitted/received between the mobile station UE#1 and the mobile station UE#2 through a Ud interface.

That is, the mobile station UE#1 can transmit/receive a data signal to/from the mobile station UE#2 through the radio base station eNB (through the Uu interface), and can also transmit/receive a data signal to/from the mobile station UE#2 without through the radio base station eNB (through the Ud interface).

Similarly, the mobile station UE#2 can transmit/receive a data signal to/from the mobile station UE#1 through the radio base station eNB (through the Uu interface), and can also transmit/receive a data signal without through the radio base station eNB (through the Ud interface).

Here, security (detection of concealment or falsification) is applied to the data signal transmitted/received through the Uu interface or the Ud interface. To apply the security, a common key is prepared between transmission/reception entities.

Methods of generating and updating a key used in the Uu interface of the LTE system are defined in TS33.401 of 3GPP and the like. The present invention relates to a method of updating a key Kₓ used in the Ud interface.

Configurations of the mobile stations UE#1 and UE#2 are basically the same, and therefore, hereinafter, the configuration of the mobile station UE#1 will be described as a representative example.

As illustrated in FIG. 2, the mobile station UE#1 is provided with a management unit 11, a packet data convergence protocol (PDCP) layer function unit 12a, a radio link control (RLC) layer function unit 12b, a transmission unit 13, a reception unit 14, and an update unit 15.

The management unit 11 is configured to control the key Kₓ to be used for security of a data signal transmitted/received through the Ud interface.

The transmission unit 13 is configured to transmit a data signal and a control signal to the radio base station eNB through the Uu interface, and to transmit a data signal to the mobile station UE#2 through the Ud interface.

The reception unit 14 is configured to receive a data signal and a control signal from the radio base station eNB through the Uu interface, and to receive a data signal from the mobile station UE#2 through the Ud interface.

The PDCP layer function unit 12a is configured to perform processing in a PDCP layer.

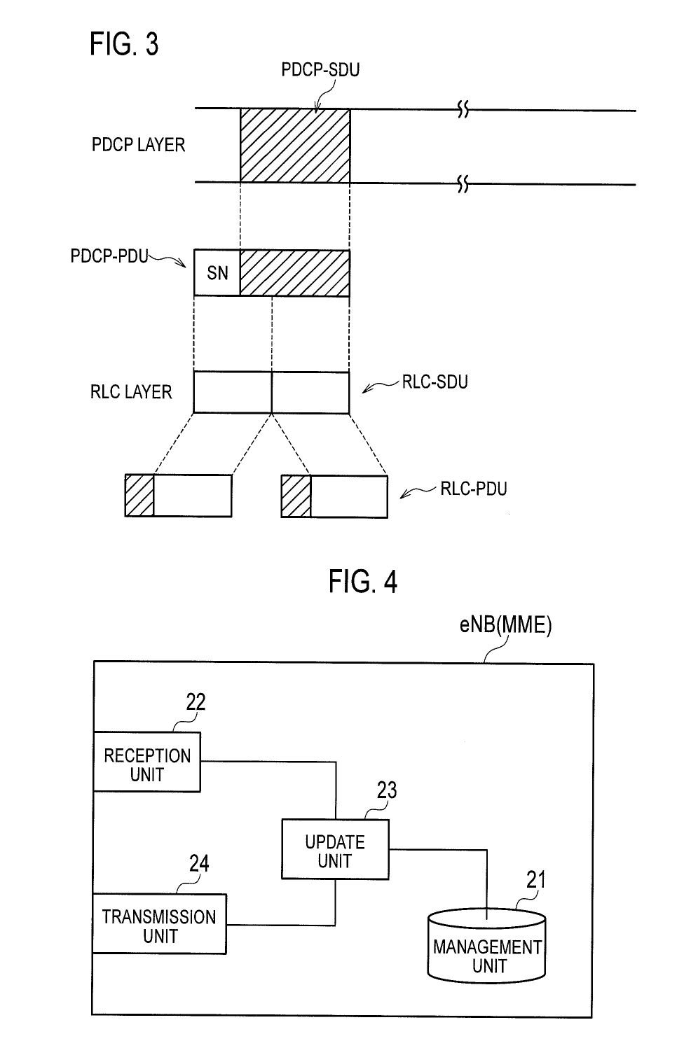

For example, as illustrated in FIG. 3, the PDCP layer function unit 12a is configured to use an IP packet received from an upper layer as a service data unit (PDCP-SDU), to generate a protocol data unit (PDCP-PDU) by providing the PDCP-SDU with a header including a sequence number SN in the PDCP layer, and to transmit the PDCP-PDU to the RLC layer function unit 12b.

Here, the PDCP layer function unit 12a is configured to apply ciphering processing to each PDCP-SDU to be transmitted using the key Kₓ or a key calculated from the key Kₓ.

Similarly, the PDCP layer function unit 12a is configured to apply deciphering processing with respect to each received PDCP-SDU using the key Kₓ or a key calculated from the key Kₓ.

In addition, the PDCP layer function unit 12a may be configured to apply integrity protection processing for each PDCP-SDU using the key Kₓ or a key calculated from the key Kₓ.

That is, the PDCP layer function unit 12a may generate a MAC-I corresponding to a checksum for each PDCP-SDU to be transmitted, and may include the MAC-I in the header. In this case, the PDCP layer function unit 12a examines the MAC-I for each received PDCP-SDU and detects falsification.

Further, the PDCP layer function unit 12a is configured to generate a “PDCP status report” based on the sequence number SN included in the header of the PDCP-PDU in a RLC-SDU received from the RLC layer function unit 12b.

In addition, the PDCP layer function unit 12a is configured to generate an “SN wrap indication” when having detected that a timing of one cycle of the sequence number (for example, the sequence number used in the PDCP layer) of the data signal transmitted/received through the Ud interface is approaching.

For example, in a case where the sequence number in the PDCP layer circulates in a range of “0” to “127” and is used, the PDCP layer function unit 12a may be configured to generate the “SN wrap indication” to the transmission unit 13 when having provided the header including a sequence number “120”.

Alternatively, in a case where the sequence number in the PDCP layer circulates in the range of “0” to “127” and is used, the PDCP layer function unit 12a may be configured to generate the “SN wrap indication” to the transmission unit 13 when having received the PDCP-PDU to which the header including the sequence number “120” is provided.

The RLC layer function unit 12b is configured to generate a RLC-PDU by appropriately dividing and combining one or more PDCP-SDUs from/with the PDCP-PDU received from the PDCP layer function unit 12a so that the PDCP-PDU has a predetermined size and by providing the RLC-PDU with a header, and to transmit the RLC-PDU to a media access control (MAC) layer.

Here, the transmission unit 13 is configured to transmit the PDU processed in each layer of the PDCP, RLC, and MAC to the mobile station UE#2 as a data signal through the Ud interface without through the Uu interface.

In addition, the transmission unit 13 is configured to transmit the “SN wrap indication” generated in the PDCP layer function unit 12a to the mobile management node MME or to the radio base station eNB.

Note that the “SN wrap indication” may be transmitted as a RRC message or a NAS message instead of a control signal of the PDCP layer.

In addition, the “SN wrap indication” may be defined as a “key update request signal” that requests update of the key.

Further, the reception unit 14 is configured to receive a data signal including the “PDCP status report” through the Ud interface without through the Uu interface from the mobile station UE#2.

The update unit 15 is configured to update the key Kₓ managed by the management unit 11.

For example, the update unit 15 may be configured to replace the key Kₓ managed by the management unit 11 with the key Kₓ received from the mobile management node MME or from the radio base station eNB by the reception unit 14.

Alternatively, the update unit 15 may be configured to calculate the key Kₓ based on a predetermined parameter X received from the mobile management node MME or from the radio base station eNB by the reception unit 14, and to replace the key Kₓ managed by the management unit 11 with the calculated key Kₓ .

In addition, the update unit 15 maybe configured to reset protocol entities of the RLC layer (layer 2) or lower layers in the Ud interface when updating the key Kₓ to be used for transmission/reception of a data signal through the Ud interface.

Note that the PDCP layer function unit 12a may be configured to generate the “PDCP status report” when the above-described key Kₓ or the predetermined parameter X is received by the reception unit 14.

As illustrated in FIG. 4, the radio base station eNB or the mobile management node MME is provided with a management unit 21, a reception unit 22, an update unit 23, and a transmission unit 24.

The management unit 21 is configured to manage the key Kₓ (or the predetermined parameter X for calculating the key Kₓ) for communication through the Ud interface in the mobile stations UE.

The reception unit 22 is configured to receive a data signal and a control signal transmitted by each mobile station UE.

For example, the reception unit 22 is configured to receive the “SN wrap indication” transmitted by each mobile station UE.

The update unit 23 is configured to update the key Kₓ (or the predetermined parameter X for calculating the key Kₓ) for communication performed between the mobile station UE (for example, the mobile station UE#1) that is a transmission source of the “SN wrap indication” and the mobile station UE (for example, the mobile station UE#2) that is a communication partner through the Ud interface when the reception unit 22 has received the “SN wrap indication”.

Here, the update unit 23 may cause the key Kₓ (or the predetermined parameter X for calculating the key Kₓ) to be transmitted to the mobile station UE that is the transmission source and the key Kₓ (or the predetermined parameter X for calculating the key Kₓ) to be transmitted to the mobile station UE that is the communication partner to be the same key Kₓ or to be different keys Kₓ.

The transmission unit 24 is configured to transmit a data signal and a control signal to the mobile station UE.

For example, the transmission unit 24 is configured to transmit the key Kₓ (or the predetermined parameter X for calculating the key Kₓ) updated by the update unit 23 to the mobile station UE that is the transmission source of the “SN wrap indication” and to the mobile station UE that is the communication partner thereof.

The transmission unit 24 may transmit the key Kₓ (or the predetermined parameter X for calculating the key Kₓ) updated by the update unit 23 as a control signal of the PDCP layer or as a RRC message or a NAS message.

Hereinafter, an operation of a case in which transmission/reception of a data signal between the mobile station UE#1 and the mobile station UE#2 through the Ud interface is performed in the mobile communication system according to the present embodiment will be described with reference to FIG. 5.

As illustrated in FIG. 5, at step S1001, when the mobile station UE#1 has detected that a timing of one cycle of the sequence number used in the PDCP layer at the transmission side is approaching, at step S1002, the mobile station UE#1 transmits the “SN wrap indication” to the radio base station eNB or to the mobile management node MME.

Here, at step S1001, when having detected the timing of one cycle of the sequence number used in the PDCP layer at the reception side is approaching, at step S1002, the mobile station UE#1 may transmit the “SN wrap indication” to the radio base station eNB or to the mobile management node MME.

At step S1003, when having received the “SN wrap indication”, the radio base station eNB or the mobile management node MME updates the key Kₓ (or the predetermined parameter X for calculating the key Kₓ) for communication between the mobile station UE#1 and the mobile station UE#2 At step S1004a, the radio base station eNB or the mobile management node MME transmits the key Kₓ (or the predetermined parameter X for calculating the key Kₓ) to the mobile station UE#1, and, at step S1004b, transmits the key Kₓ (or the predetermined parameter X for calculating the key Kₓ) to the mobile station UE#2.

Here, the key Kₓ (or the predetermined parameter X for calculating the key Kₓ) transmitted to the mobile station UE#1 and the key Kₓ (or the predetermined parameter X for calculating the key Kₓ) transmitted to the mobile station UE#2 may be the same or may be different.

At step S1005a, the mobile station UE#1 updates the key Kₓ for communication with the mobile station UE#2, and at step S1005b, the mobile station UE#2 updates the key Kₓ for communication with the mobile station UE#1.

At step S1006a, the mobile station UE#1 transmits, to the radio base station eNB or to the mobile management node MME, a response signal that notifies completion of the update of the key Kₓ for communication with the mobile station UE#2. At step S1006b, the mobile station UE#2 transmits, to the radio base station eNB or to the mobile management node MME, a response signal that notifies completion of the update of the key Kₓ for communication with the mobile station UE#1.

Following that, the transmission/reception of a data signal between the mobile station UE#1 and the mobile station UE#2 is continued using the updated key Kₓ.

Note that the radio base station eNB or the mobile management node MME may stop allocation of a new Ud interface from when transmitting the key Kₓ (or the predetermined parameter X for calculating the key Kₓ) at step S1004a/S1004b to when receiving the response signal at step S1006a/S1006b.

In addition, the mobile station UE#1 and the mobile station UE#2 reset the protocol entities of the RLC layer or lower layers of the Ud interface when having received the key Kₓ (or the predetermined parameter X for calculating the key Kₓ) from the radio base station eNB or from the mobile management node MME at step S1004a/S1004b.

That is, in that case, the mobile station UE#1 and the mobile station UE#2 destroy the PDU accumulated in a buffer, and reset the HARQ process of the MAC and the like.

In addition, following that, the mobile station UE#1 and the mobile station UE#2 exchange the “PDCP status report” each other and cause states of the SNs of the PDCP-SDUs with which the transmission/reception is to be resumed to accord with each other when having received resource allocation of transmission/reception on a new Ud interface from the radio base station eNB.

According to the mobile communication system of the first embodiment of the present invention, when the mobile station UE#1 at the transmission side or at the reception side has detected the timing of one cycle of the sequence number used in the PDCP layer is approaching, the key Kₓ for communication between the mobile station UE#1 and the mobile station UE#2 can be updated, and therefore, the security in communication between the mobile station UE#1 and the mobile station UE#2 can be secured.

The features of the above-described present embodiment may be expressed in the following manner.

The first feature of the present embodiment is a mobile communication method in which a mobile station UE#1 (first mobile station) and a mobile station UE#2 (second mobile station) perform transmission/reception of a data signal through a Ud interface (interface between mobile stations) set between the mobile station UE#1 and the mobile station UE#2 without through a Uu interface (radio base station interface) set between the mobile station UE#1 and the mobile station UE#2, and a radio base station eNB. The method includes: a step of transmitting, from the mobile station UE#1 or the mobile station UE#2 to the radio base station eNB, an “SN wrap indication (instruction signal indicating a timing of one cycle of a sequence number of the data signal transmitted/received through the interface between mobile stations is approaching)” or a key update request signal that requests update of a key; a step of updating, by the radio base station eNB or a mobile management node MME, a key Kₓ (key for communication between mobile stations) to be used for transmission/reception of the data signal through the Ud interface or a predetermined parameter X for calculating the key Kₓ when having received the “SN wrap indication” or the key update request signal; a step of notifying, by the radio base station eNB or the mobile management node MME, the mobile station UE#1 and the mobile station UE#2 of the updated key Kₓ or the updated predetermined parameter X; and a step of updating, by the mobile station UE#1 and the mobile station UE#2, the key Kₓ to be used for transmission/reception of the data signal through the Ud interface to a key Kₓ calculated based on the notified key Kₓ or the notified predetermined parameter X.

The first feature of the present embodiment may include a step of performing transmission/reception of the “PDCP status report” between the mobile station UE#1 and the mobile station UE#2 through the Ud interface without through the Uu interface.

In a first feature of the present embodiment, the transmission/reception of the “PDCP status report” may be performed when the updated key Kₓ or the predetermined parameter X is received.

The first feature of the present embodiment may include a step of transmitting a response signal indicating a fact of update to the radio base station eNB or to the mobile management node MME when the mobile station UE#1 and the mobile station UE#2 have updated the key Kₓ to be used for transmission/reception of a data signal through the Ud interface to the key Kₓ calculated based on the notified key Kₓ or the predetermined parameter X.

In the first feature of the present embodiment, the radio base station eNB or the mobile management node MME may stop allocation of a new Ud interface from when notifying the key Kₓ or the predetermined parameter X to the mobile station UE#1 and the mobile station UE#2 to when receiving the response signal.

In the first feature of the present embodiment, the mobile station UE#1 and the mobile station UE#2 may reset the protocol entities of the RLC layer (layer 2) or lower layers in the Ud interface when updating the key Kₓ to be used for transmission/reception of a data signal through the Ud interface.

The second feature of the present embodiment is a radio base station eNB to be used in a mobile communication system configured to perform transmission/reception of a data signal between a mobile station UE#1 and a mobile station UE#2 through a Ud interface without through a Uu interface. The radio base station eNB includes: a reception unit 22 configured to receive an “SN wrap indication” or a key update request signal from the mobile station UE#1 or the mobile station UE#2; an update unit 23 configured to update a key Kₓ or a predetermined parameter X when having received the “SN wrap indication” or the key update request signal; and a transmission unit 24 configured to notify the mobile station UE#1 and the mobile station UE#2 of the updated key Kₓ or the updated predetermined parameter X.

The second feature of the present embodiment may be configured to stop the allocation of a new Ud interface from when notifying the mobile station UE#1 and the mobile station UE#2 of the key Kₓ or the predetermined parameter X to when receiving the response signal indicating completion of the update of the key Kₓ from the mobile station UE#1 and the mobile station UE#2.

The third feature of the present embodiment is a mobile management node MME to be used in a mobile communication system configured to perform transmission/reception of a data signal between a mobile station UE#1 and a mobile station UE#2 through a Ud interface without through a Uu interface. The mobile management node MME includes: a reception unit 22 configured to receive an “SN wrap indication” or a key update request signal from the mobile station UE#1 or the mobile station UE#2; a update unit 23 configured to update a key Kₓ or a predetermined parameter X when having received the “SN wrap indication” or the key update request signal; and a transmission unit 24 configured to notify the mobile station UE#1 and the mobile station UE#2 of the updated key Kₓ or the updated predetermined parameter X.

The third feature of the present embodiment may be configured to stop the allocation of a new Ud interface from when notifying the mobile station UE#1 and the mobile station UE#2 of the key Kₓ or the predetermined parameter X to when receiving the response signal indicating completion of the update of the key Kₓ from the mobile station UE#1 and the mobile station UE#2.

The fourth feature of the present embodiment is a mobile station UE#1 to be used in a mobile communication system configured to perform transmission/reception of a data signal with a mobile station UE#2 through a Ud interface without through a Uu interface. The mobile station UE#1 includes: a transmission unit 13 configured to transmit an “SN wrap indication” or a key update request signal to a radio base station eNB; a reception unit 14 configured to receive a key Kₓ or a predetermined parameter X from the radio base station eNB or a mobile management node MME that has received the “SN wrap indication” or the key update request signal; and an update unit 15 configured to update the key Kₓ to be used for transmission/reception of the data signal through the Ud interface to a key Kₓ calculated based on the received key Kₓ or the received predetermined parameter X.

In the fourth feature of the present embodiment, the transmission unit 13 and the reception unit 14 maybe configured to perform transmission/reception of the “PDCP status report” to/from the mobile station UE#2 through the Ud interface without through the Uu interface.

In the fourth feature of the present embodiment, the transmission unit 13 and the reception unit 14 maybe configured to perform transmission/reception of the “PDCP status report” when the updated key Kₓ or the predetermined parameter X is received.

In the fourth embodiment of the present embodiment, the update unit 15 maybe configured to reset the protocol entities of the RLC layer (layer 2) or lower layers in the Ud interface when updating the key Kₓ used for transmission/reception of a data signal through the Ud interface.

Note that the above-described operations of the radio base station eNB, the mobile stations UE, and the like may be implemented by hardware, by a software module executed by a processor, or by combination of the hardware and the software module.

The software module may be provided in a storage medium in an arbitrary format such as a random access memory (RAM), a flash memory, a read only memory (ROM), an erasable programmable ROM (EPROM), an electrically erasable and programmable ROM (EEPROM), a register, a hard disk, a removable disk, and a CD-ROM.

The storage medium is connected to the processor so that the processor can read/write information in the storage medium. In addition, the storage medium may be integrated in the processor. In addition, the storage medium and the processor may be provided in the ASIC. The ASIC may be provided in the radio base station eNB, the mobile station UE, and the like. In addition, the storage medium and the processor may be provided in the radio base station eNB, the mobile stations UE, and the like as a discrete component.

As described above, while the present invention has been described in details using the embodiment, it is apparent for a person skilled in the art that the present invention is not limited to the embodiment described in the present specification. The present invention can be implemented as a modification or an alternation without departing from the gist and scope of the present invention defined by the description of claims. Therefore, the description of the present specification intends illustration, and does not have any restrictive meaning to the present invention.

### REFERENCE SIGNS LIST

UE Mobile station
eNB Radio base station eNB
MME Mobile management node
11 and 21 Management unit
12a PDCP layer function unit
12b RLC layer function unit
13 and 24 Transmission unit
14 and 22 Reception unit
15 and 24 Update unit

1. A mobile communication method of performing transmission/reception of a data signal between a first mobile station and a second mobile station through an interface between mobile stations set between the first mobile station and the second mobile station without through a radio base station interface set between the first mobile station and the second mobile station, and the radio base station, the method comprising the steps of:
transmitting, to the radio base station from the first mobile station or the second mobile station, an instruction signal indicating a timing of one cycle of a sequence number of the data signal transmitted/received through the interface between mobile stations is approaching, or a key update request signal requesting update of a key;
updating, by the radio base station or a mobile management node, a key for communication between mobile stations to be used for transmission/reception of the data signal through the interface between mobile stations, or a predetermined parameter for calculating the key for communication between mobile stations when the radio base station or the mobile management node has received the instruction signal or the key update request signal;
notifying, by the radio base station or the mobile management node, the first mobile station and the second mobile station of the updated key for communication between mobile stations or the updated predetermined parameter; and
updating, by the first mobile station and the second mobile station, the key for communication between mobile stations to be used for transmission/reception of the data signal through the interface between mobile stations to a key for communication between mobile stations calculated based on the notified key for communication between mobile stations or the notified predetermined parameter.

2. The mobile communication method according to claim 1, comprising a step of performing, between the first mobile station and the second mobile station, transmission/reception of a PDCP status report through the interface between mobile stations without through the radio base station interface.

3. The mobile communication method according to claim 2, wherein the transmission/reception of a PDCP status report is performed when the updated key for communication between mobile stations or the updated predetermined parameter is received.

4. The mobile communication method according to claim 1, comprising a step of transmitting, to the radio base station or the mobile management node from the first mobile station and the second mobile station, a response signal indicating a fact of update when the first mobile station and the second mobile station have updated the key for communication between mobile stations to be used for transmission/reception of the data signal through the interface between mobile stations to the key for communication between mobile stations calculated based on the notified key for communication between mobile stations or the notified predetermined parameter.

5. The mobile communication method according to claim 4, wherein the radio base station or the mobile management node stops allocation of a new interface between mobile stations from when notifying the first mobile station and the second mobile station of the key for communication between mobile stations or the predetermined parameter to when receiving the response signal.

6. The mobile communication method according to claim 1, wherein the first mobile station and the second mobile station reset protocol entities of a RLC layer or lower layers in the interface between mobile stations when updating the key for communication between mobile stations to be used for transmission/reception of the data signal through the interface between mobile stations.

7. A radio base station to be used in a mobile communication system configured to perform transmission/reception of a data signal between a first mobile station and a second mobile station through an interface between mobile stations set between the first mobile station and the second mobile station without through a radio base station interface set between the first mobile station and the second mobile station, and the radio base station, the radio base station comprising:
a reception unit configured to receive, from the first mobile station or the second mobile station, an instruction signal indicating a timing of one cycle of a sequence number of the data signal transmitted/received through the interface between mobile stations is approaching, or a key update request signal requesting update of a key;
an update unit configured to update a key for communication between mobile stations to be used for transmission/reception of the data signal through the interface between mobile stations, or a predetermined parameter for calculating the key for communication between mobile stations when having received the instruction signal or the key update request signal; and
a transmission unit configured to notify the first mobile station and the second mobile station of the updated key for communication between mobile stations or the updated predetermined parameter.

8. The radio base station according to claim 7 configured to stop allocation of a new interface between mobile stations from when notifying the key for communication between mobile stations or the predetermined parameter to the first mobile station and the second mobile station to when receiving a response signal indicating completion of update of the key for communication between mobile stations from the first mobile station and the second mobile station.

9. A mobile management node to be used in a mobile communication system configured to perform transmission/reception of a data signal between a first mobile station and a second mobile station through an interface between mobile stations set between the first mobile station and the second mobile station without through a radio base station interface set between the first mobile station and the second mobile station, and a radio base station, the mobile management node comprising:
a reception unit configured to receive, from the first mobile station or the second mobile station, an instruction signal indicating a timing of one cycle of a sequence number of the data signal transmitted/received through the interface between mobile stations is approaching, or a key update request signal requesting update of a key;
an update unit configured to update a key for communication between mobile stations to be used for transmission/reception of the data signal through the interface between mobile stations, or a predetermined parameter for calculating the key for communication between mobile stations when having received the instruction signal or the key update request signal; and
a transmission unit configured to notify the first mobile station and the second mobile station of the updated key for communication between mobile stations, or the updated predetermined parameter.

10. The mobile management node according to claim 9 configured to stop allocation of a new interface between mobile stations from when notifying the first mobile station and the second mobile station of the key for communication between mobile stations or the predetermined parameter to when receiving a response signal indicating completion of update of the key for communication between mobile stations from the first mobile station and the second mobile station.

11. A mobile station functioning as a first mobile station in a mobile communication system configured to perform transmission/reception of a data signal between the first mobile station and a second mobile station through an interface between mobile stations set between the first mobile station and the second mobile station without through a radio base station interface set between the first mobile station and the second mobile station, and a radio base station, the mobile station comprising:
a transmission unit configured to transmit, to the radio base station, an instruction signal indicating a timing of one cycle of a sequence number of the data signal transmitted/received through the interface between mobile stations is approaching, or a key update request signal requesting update of a key;
a reception unit configured to receive, from the radio base station or a mobile management node having received the instruction signal or the key update request signal, a key for communication between mobile stations to be used for transmission/reception of the data signal through the interface between mobile stations, or a predetermined parameter for calculating the key for communication between mobile stations; and
an update unit configured to update the key for communication between mobile stations to be used for transmission/reception of the data signal through the interface between mobile stations to a key for communication between mobile stations calculated based on the received key for communication between mobile stations or the received predetermined parameter.

12. The mobile station according to claim 11, wherein the transmission unit and the reception unit are configured to perform transmission/reception of a PDCP status report with the second mobile station through the interface between mobile stations without through the radio base station interface.

13. The mobile station according to claim 12, wherein the transmission unit and the reception unit are configured to perform transmission/reception of the PDCP status report when the updated key for communication between mobile stations, or the updated predetermined parameter is received.

14. The mobile station according to claim 11, wherein the update unit is configured to reset protocol entities of an RLC layer or lower layers in the interface between mobile stations when updating the key for communication between mobile stations to be used for transmission/reception of the data signal through the interface for mobile stations.
